(19) United States
(12) Patent Application Publication
(10) Pub. No.: US 2008/0038053 A1
(43) Pub. Date: Feb. 14, 2008

(54) FASTENING MECHANISM FOR DISPLAY DEVICE

(76) Inventor: Yu-Jen Lai, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/558,932

(22) Filed: Nov. 12, 2006

(30) Foreign Application Priority Data
Jul. 21, 2006 (TW) 095126795

(51) Int. Cl. B25G 3/20

(52) U.S. Cl. 403/371

(57) ABSTRACT

The fastening mechanism includes a first component, a second component, and a first connecting component. The first component has a first annular structure, wherein a first through hole is formed within the first annular structure. The second component has a seat. The first connecting component has a second annular structure, wherein a second through hole is formed within the second annular structure, the first connecting component is disposed within the first through hole, and the second annular structure is engaged with an outer surface of the seat, so the seat is partly disposed within the second through hole. Moreover, the seat is partly disposed within the second through hole at a preset depth for fastening the first component to the second component.

### BACKGROUND OF THE INVENTION

1. Field of the Invention

The present invention relates to a fastening mechanism, and more particularly, to a fastening mechanism for a display device.

2. Description of the Prior Art

Many electronic products in the market have display devices for displaying image signals, for example, personal computers (PCs), personal digital assistants (PDAs), liquid crystal display televisions (LCD TVs), or notebook computers. A display device usually comprises a display unit (such as an LCD panel) displaying an image signal, and a cover. The cover comprises a front cover and a back cover engaged with each other to form an inner space, and the display unit is disposed in the inner space.

Typically, the front cover partly covers the display unit, and the display unit is exposed out of the front cover to a user, such that the user can view the displayed image signal. The value of a clearance between the front cover and the display unit is thus very important and should be appropriately set when the display device is assembled. Additionally speaking, if the clearance is too big, dust or some unknown object may enter the display device through the clearance. On the contrary, if the clearance is too small, the front cover may compress the display unit, thereby causing uneven brightness or poor equality on the display unit. Thus, an assemblage method and corresponding components should be proposed to limit the clearance between the front cover and the display unit in an appropriate range.

### SUMMARY OF THE INVENTION

It is therefore one of the objectives of the present invention to provide a fastening mechanism to solve the above mentioned problems of the prior art. The fastening mechanism comprises a first component, having a first annular structure, wherein a first through hole is formed within the first annular structure; a second component, having a seat; and a first connecting component, having a second annular structure, wherein a second through hole is formed within the second annular structure, the first connecting component is disposed within the first through hole, and the second annular structure is engaged with an outer surface of the seat, so the seat is partly disposed within the second through hole; wherein the seat is partly disposed within the second through hole at a preset depth for fastening the first component to the second component.

The present invention further provides a fastening mechanism for a display device, comprising a display unit, for displaying an image signal; a first component, connected to the display unit and having a first annular structure, wherein a first through hole is formed within the first annular structure; a second component, having a seat and a front cover connected with each other, wherein the front cover partly covers the display unit; and a first connecting component, having a second annular structure, wherein a second through hole is formed within the second annular structure, the first connecting component is disposed within the first through hole, and the second annular structure is engaged with an outer surface of the seat, so the seat is partly disposed within the second through hole; wherein the seat is partly disposed within the second through hole at a preset depth for fastening the first component to the second component.

The present invention further provides a fastening mechanism, comprising a first component, having a first annular structure, wherein a first through hole is formed within the first annular structure; a second component, having a seat, wherein the seat has a combining hole; a first connecting component, having a second annular structure, wherein a second through hole is formed within the second annular structure, the first connecting component is disposed within the first through hole, and the second annular structure is engaged with an outer surface of the seat, so the seat is partly disposed within the second through hole; and a second connecting component, passing through the second through hole to be disposed in the combining hole; wherein rigidity of the first connecting component is less than that of the first component, that of the second component, and that of the second connecting component respectively, and the seat is partly disposed within the second through hole at a preset depth for fastening the first component to the second component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a three-dimensional view of a display device assembled utilizing a fastening mechanism of the present invention.

FIG. 2 is an exploded view of a fastening mechanism of the present invention.

FIG. 3 is another exploded view of a fastening mechanism of the present invention before assemblage.

FIG. 4 is a sectional view of the fastening mechanism in FIG. 3 after assemblage.

FIG. 5 is a three-dimensional view of a first connecting component of the present invention.

FIG. 6 is a sectional view of another example of a fastening mechanism of the present invention after assemblage.

FIG. 7 is a three-dimensional view of another example of a first connecting component of the present invention.

### DETAILED DESCRIPTION

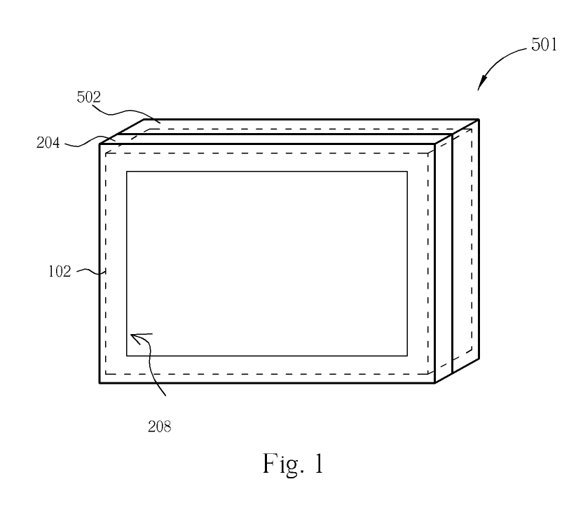

FIG. 1 is a three-dimensional view of a display device 501 assembled utilizing a fastening mechanism 101 of the present invention. As shown in FIG. 1, the display device 501 comprises a display unit 102, a front cover 204, and a back cover 502. The display unit 102 is a liquid crystal display (LCD) panel or a plasma display panel (PDP) for displaying an image signal. The front cover 204 is engaged with the back cover 502 to form an inner space, and the display unit 102 is disposed in the inner space. The front cover 204 partly covers the display unit 102, and the display unit 102 is exposed out of the front cover 204 to a user, such that the user can view the displayed image signal. Moreover, there exists a clearance 208 between the front cover 204 and the display unit 102.

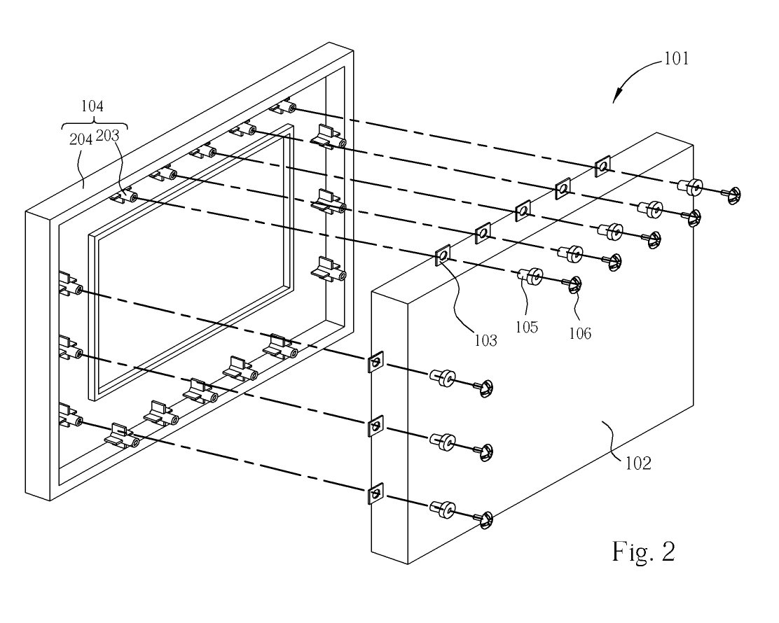

FIG. 2 is an exploded view of the fastening mechanism 101. As shown in FIG. 2, the fastening mechanism 101 comprises the display unit 102, a plurality of first components 103, a second component 104, a plurality of first connecting components 105, and a plurality of second connecting components 106. The second component 104 comprises the front cover 204 and a plurality of seats 203.

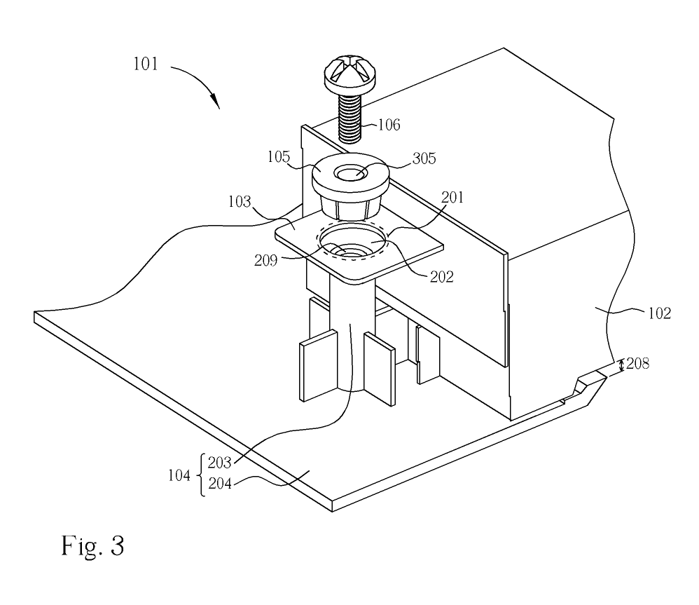

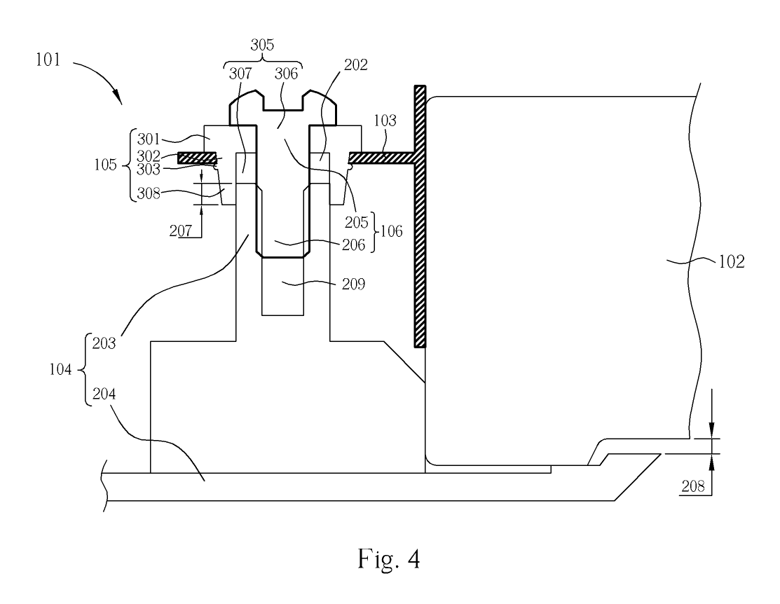

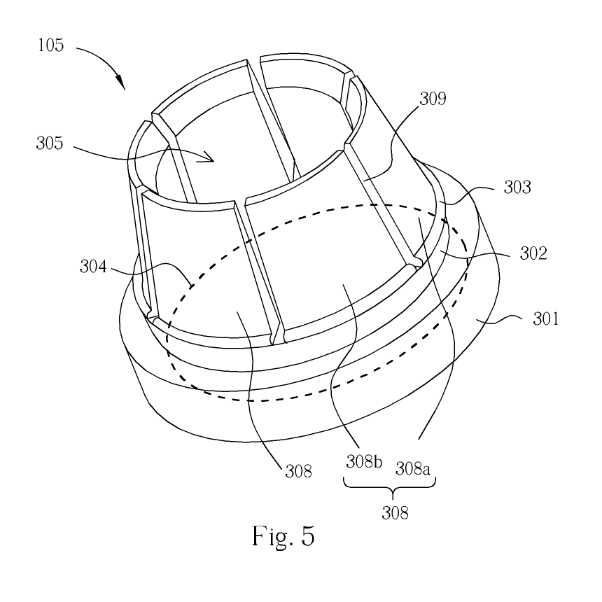

FIG. 3 is another exploded view of the fastening mechanism 101 before assemblage. FIG. 4 is a sectional view of the fastening mechanism 101 in FIG. 3 after assemblage. Please note that although FIGS. 3 and 4 show only one first component 103, one first connecting component 105, one second connecting component 106, and one seat 203, any other similar component in the present invention can be assembled in the same way as shown in these two figures. Those skilled in the art will readily apply the assemblage method as shown in these two figures to the whole fastening mechanism 101. Additionally, FIG. 5 is a three-dimensional view of the first connecting component 105. Please refer to FIGS. 3-5 while reading the following detailed description.

As shown, the first component 103 is connected to the display unit 102 and has a first annular structure 201, and a first through hole 202 is formed within the first annular structure 201. As described above, the second component 104 comprises the seat 203 and the front cover 204. The seat 203 is connected to the front cover 204 and has a combining hole 209.

The first connecting component 105 is disposed within the first through hole 202 and is engaged with the first annular structure 201. Moreover, the first connecting component 105 has a second annular structure 304 and a plurality of fan-shaped portions 308. The second annular structure 304 comprises a head portion 301, a neck portion 302, and a protrusion portion 303.

The neck portion 302 is connected between the head portion 301 and the protrusion portion 303. The fan-shaped portions 308 substantially extend from the second annular structure 304. Moreover, the head portion 301, the neck portion 302, the protrusion portion 303, and the fan-shaped portions 308 are integral. Regarding the sizes, a second outer dimension of the neck portion 302 is smaller than or equals to an inner dimension of the first through hole 202, and a first outer dimension of the head portion 301 and a third outer dimension of the protrusion portion 303 are both bigger than an inner dimension of the first annular structure 201. Therefore, when the neck portion 302 of the first connecting component 105 is disposed in the first through hole 202, the head portion 301 and the protrusion portion 303 of the first connecting component 105 respectively contact with an upper side and a lower side of the first annular structure 201, thereby fastening the first connecting component 105 to the first annular structure 201.

Moreover, a second through hole 305 is formed within the second annular structure 304. The second annular structure 304 is engaged with an outer surface of the seat 203. Thus, the seat 203 is partly disposed within the second through hole 305 at a preset depth 207. Additionally, the second annular structure 304 comprises a first segment 306 and a second segment 307. Regarding the sizes, an inner dimension of the first segment 306 is smaller than an inner dimension of the second segment 307, and the inner dimension of the first segment 306 of the second annular structure 304 is substantially close to an outer dimension of the second connecting component 106. Moreover, the inner dimension of the second segment 307 of the second annular structure 304 is substantially close to but slightly smaller than an outer dimension of the seat 203, such that the second annular structure 304 is tightly engaged with the seat 203 by the second segment 307.

Furthermore, the fan-shaped portions 308 comprise at least a first fan-shaped portion 308a and a second fan-shaped portion 308b. The fan-shaped portions 308, including the first fan-shaped portion 308a and the second fan-shaped portion 308b, are arranged in an annular manner outside the second through hole 305 to receive the seat 203. Additionally, there exists a clearance 309 between the first fan-shaped portion 308a and the second fan-shaped portion 308b for allowing the first fan-shaped portion 308a to change shape without interference from the second fan-shaped portion 308b.

The second connecting component 106 passes through the second through hole 305 to be disposed in the combining hole 209. As described above, the inner dimension of the first segment 306 of the second annular structure 304 is substantially close to the outer dimension of the second connecting component 106, such that an upper end 205 of the second connecting component 106 is tightly combined with the first segment 306 of the second annular structure 304. Moreover, the second connecting component 106 is a screw, the combining hole 209 is an internally threaded hole, and the screw fits the internally threaded hole in size and thread. Therefore, a lower end 206 of the second connecting component 106 passes through the second through hole 305 to be fixedly screwed in the combining hole 209.

In the fastening mechanism 101 of the present invention, the first component 103 is fastened to the second component 104 by the first connecting component 105 and the second connecting component 106. Please note that the fastening mechanism 101 can be preferably assembled in the following order: first, as shown in FIG. 3, aligning the seat 203 with the first through hole 202 while adjusting the clearance 208 between the front cover 204 and the display unit 102 to an appropriate value; next, as shown in FIG. 4, disposing the first connecting component 105 within the first through hole 202 to be engaged with the seat 203, wherein the seat 203 is partly disposed within the second through hole 305 at the preset depth 207; and finally, as shown in FIG. 4, passing the second connecting component (i.e. screw) 106 through the second through hole 305 to be fixedly screwed in the combining hole (i.e. internally threaded hole) 209.

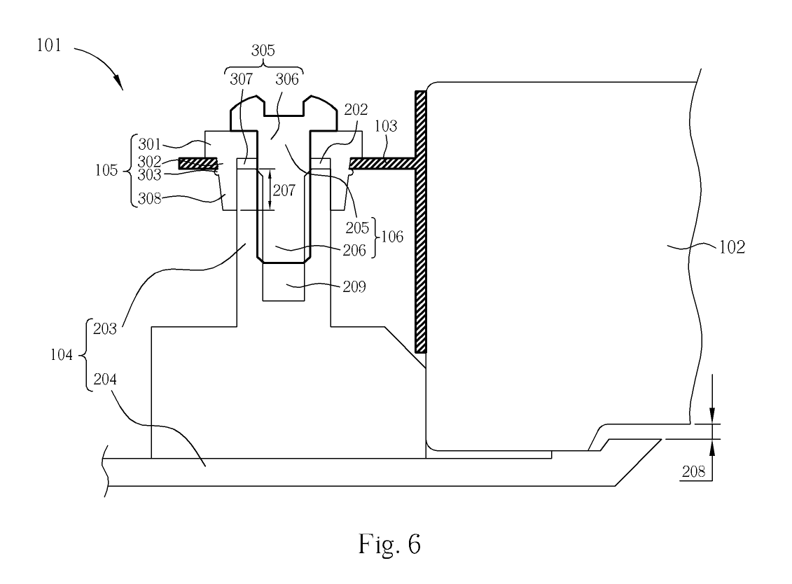

As indicated in the assemblage order, the clearance 208 between the front cover 204 and the display unit 102 can be appropriately adjusted by changing the preset depth 207 at which the seat 203 is partly disposed within the second through hole 305. Alternatively speaking, the preset depth 207 at which the seat 203 is partly disposed within the second through hole 305 can be appropriately adjusted to limit the clearance 208 between the front cover 204 and the display unit 102 in an appropriate range. For example, FIG. 6 is a sectional view of another example of the fastening mechanism 101 after assemblage. As shown, to limit the clearance 208 between the front cover 204 and the display unit 102 in an appropriate range, the preset depth 207 in FIG. 6 is appropriately adjusted and thus different from the preset depth 207 in FIG. 4.

Moreover, the first connecting component 105 is made of a flexible material, such as plastics or rubber. Thus, rigidity of the first connecting component 105 is less than that of the first component 103, that of the second component 104, and that of the second connecting component 105 respectively. Therefore, after the fastening mechanism 101 is assembled, the first connecting component 105 will change shape to conform to absolute positions, oblique degrees, shapes, and sizes of the first component 103, the second component 104, and the second connecting component 106, thereby achieving the effect of buffering. Alternatively speaking, if the first connecting component 105 is absent and the first component 103 and the second component 104 are mismatched in some degree, the first component 103 or the second component 104 will suffer from distortion when the second connecting component (i.e. screw) 106 is fixedly screwed in the combining hole (i.e. internally threaded hole) 209, thereby affecting the assemblage tolerance between the front cover 204 and the display unit 102, such as the clearance 208 between the front cover 204 and the display unit 102. However, the present invention utilizes the relatively flexible first connecting component 105 as a buffer, so the first connecting component 105 will change shape to conform to absolute positions, oblique degrees, shapes, and sizes of the first component 103, the second component 104, and the second connecting component 106 when the first component 103 and the second component 104 are mismatched in some degree. Therefore, in the present invention, the assemblage tolerance between the front cover 204 and the display unit 102, such as the clearance 208 between the front cover 204 and the display unit 102, can be appropriately set as required.

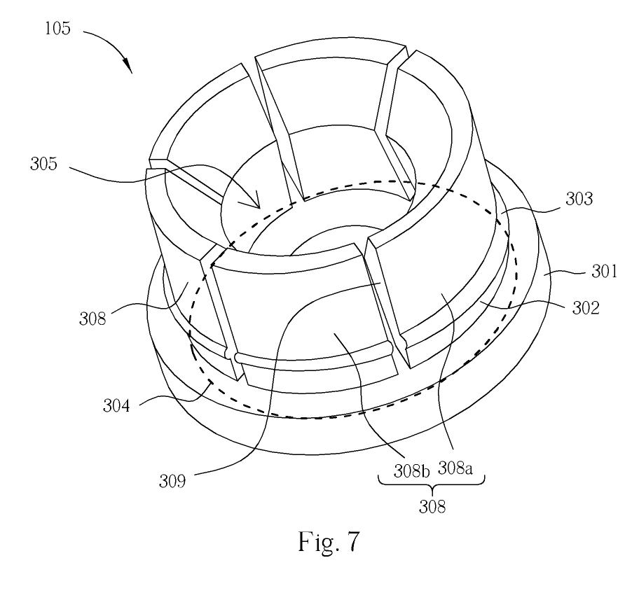

Please note that the first connecting component 105 as shown in FIG. 5 is only an example herein and is not meant to be a limitation of the present invention. Other embodiments of the present invention may utilize another first connecting component 105 of different shape. Furthermore, any component having similar functions or characteristics as disclosed in the present invention and claims thereof can be utilized as the first connecting component 105 of the present invention. For example, FIG. 7 is a three-dimensional view of another example of the first connecting component 105.

In conclusion, a fastening mechanism of the present invention utilizes a flexible first connecting component as a buffer. Therefore, a clearance between a front cover and a display unit can be appropriately adjusted by the first connecting component, thus limiting the assemblage tolerance in an appropriate range when the front cover and the display unit are assembled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fastening mechanism, comprising:
a first component, having a first annular structure, wherein a first through hole is formed within the first annular structure;
a second component, having a seat; and
a first connecting component, having a second annular structure, wherein a second through hole is formed within the second annular structure, the first connecting component is disposed within the first through hole, and the second annular structure is engaged with an outer surface of the seat, so the seat is partly disposed within the second through hole;
wherein the seat is partly disposed within the second through hole at a preset depth for fastening the first component to the second component.

2. The fastening mechanism of claim 1, wherein the first connecting component is engaged with the first annular structure, and the seat is engaged with the second annular structure.

3. The fastening mechanism of claim 1, wherein rigidity of the first connecting component is less than that of the first component and that of the second component respectively.

4. The fastening mechanism of claim 1, wherein the first connecting component is flexible, and a size of the second through hole is slightly smaller than an outer dimension of the seat for tightly engaging the seat with the second annular structure.

5. The fastening mechanism of claim 1, wherein the first connecting component comprises:
a head portion, wherein a first outer dimension of the head portion is bigger than an inner dimension of the first through hole;
a neck portion, connected to the head portion, wherein a second outer dimension of the neck portion is smaller than or equals to the inner dimension of the first through hole; and
a protrusion portion, connected to the neck portion, wherein a third outer dimension of the protrusion portion is bigger than the inner dimension of the first through hole;
wherein the neck portion is disposed in the first through hole, and the head portion and the protrusion portion respectively contact with two opposite sides of the first annular structure for fastening the first connecting component to the first annular structure.

6. The fastening mechanism of claim 1, wherein the first connecting component further has a first fan-shaped portion and a second fan-shaped portion, and the first fan-shaped portion and the second fan-shaped portion are arranged in an annular manner outside the second through hole to receive the seat.

7. The fastening mechanism of claim 6, wherein there exists a clearance between the first fan-shaped portion and the second fan-shaped portion for allowing the first fan-shaped portion to change shape without interference from the second fan-shaped portion.

8. The fastening mechanism of claim 1, further comprising a second connecting component, wherein the seat has a combining hole, and the second connecting component passes through the second through hole to be disposed in the combining hole.

9. The fastening mechanism of claim 8, wherein the combining hole is an internally threaded hole, the second connecting component is a screw, and the screw fits the internally threaded hole in size and thread, thereby enabling combination between the screw and the internally threaded hole.

10. The fastening mechanism of claim 8, wherein the first connecting component comprises:
a first segment, wherein an inner dimension of the first segment is substantially close to an outer dimension of the second connecting component; and
a second segment, wherein an inner dimension of the second segment is substantially close to an outer dimension of the seat, and the inner dimension of the first segment is smaller than the inner dimension of the second segment;
wherein the first connecting component is disposed in the first through hole, an upper end of the second connecting component is combined with the first segment, and a lower end of the second connecting component passes through the second through hole to be disposed in the combining hole.

11. A fastening mechanism for a display device, comprising:
a display unit, for displaying an image signal;
a first component, connected to the display unit and having a first annular structure, wherein a first through hole is formed within the first annular structure;
a second component, having a seat and a front cover connected with each other, wherein the front cover partly covers the display unit; and
a first connecting component, having a second annular structure, wherein a second through hole is formed within the second annular structure, the first connecting component is disposed within the first through hole, and the second annular structure is engaged with an outer surface of the seat, so the seat is partly disposed within the second through hole;
wherein the seat is partly disposed within the second through hole at a preset depth for fastening the first component to the second component.

12. The fastening mechanism of claim 11, wherein the first connecting component is engaged with the first annular structure, and the seat is engaged with the second annular structure.

13. The fastening mechanism of claim 11, wherein rigidity of the first connecting component is less than that of the first component and that of the second component respectively.

14. The fastening mechanism of claim 11, wherein the first connecting component is flexible, and a size of the second through hole is slightly smaller than an outer dimension of the seat for tightly engaging the seat with the second annular structure.

15. The fastening mechanism of claim 11, wherein the first connecting component comprises:
a head portion, wherein a first outer dimension of the head portion is bigger than an inner dimension of the first through hole;
a neck portion, connected to the head portion, wherein a second outer dimension of the neck portion is smaller than or equals to the inner dimension of the first through hole; and
a protrusion portion, connected to the neck portion, wherein a third outer dimension of the protrusion portion is bigger than the inner dimension of the first through hole;
wherein the neck portion is disposed in the first through hole, and the head portion and the protrusion portion respectively contact with two opposite sides of the first annular structure for fastening the first connecting component to the first annular structure.

16. The fastening mechanism of claim 11, wherein the first connecting component further has a first fan-shaped portion and a second fan-shaped portion, and the first fan-shaped portion and the second fan-shaped portion are arranged in an annular manner outside the second through hole to receive the seat.

17. The fastening mechanism of claim 16, wherein there exists a clearance between the first fan-shaped portion and the second fan-shaped portion for allowing the first fan-shaped portion to change shape without interference from the second fan-shaped portion.

18. The fastening mechanism of claim 11, further comprising a second connecting component, wherein the seat has a combining hole, and the second connecting component passes through the second through hole to be disposed in the combining hole.

19. The fastening mechanism of claim 18, wherein the combining hole is an internally threaded hole, the second connecting component is a screw, and the screw fits the internally threaded hole in size and thread, thereby enabling combination between the screw and the internally threaded hole.

20. The fastening mechanism of claim 18, wherein the first connecting component comprises:
a first segment, wherein an inner dimension of the first segment is substantially close to an outer dimension of the second connecting component; and
a second segment, wherein an inner dimension of the second segment is substantially close to an outer dimension of the seat, and the inner dimension of the first segment is smaller than the inner dimension of the second segment;
wherein the first connecting component is disposed in the first through hole, an upper end of the second connecting component is combined with the first segment, and a lower end of the second connecting component passes through the second through hole to be disposed in the combining hole.

21. A fastening mechanism, comprising:
a first component, having a first annular structure, wherein a first through hole is formed within the first annular structure;
a second component, having a seat, wherein the seat has a combining hole;
a first connecting component, having a second annular structure, wherein a second through hole is formed within the second annular structure, the first connecting component is disposed within the first through hole, and the second annular structure is engaged with an outer surface of the seat, so the seat is partly disposed within the second through hole; and
a second connecting component, passing through the second through hole to be disposed in the combining hole;
wherein rigidity of the first connecting component is less than that of the first component, that of the second component, and that of the second connecting component respectively, and the seat is partly disposed within the second through hole at a preset depth for fastening the first component to the second component.

22. The fastening mechanism of claim 21, wherein the first connecting component is engaged with the first annular structure, and the seat is engaged with the second annular structure.

23. The fastening mechanism of claim 21, wherein the first connecting component is flexible, and a size of the second through hole is slightly smaller than an outer dimension of the seat for tightly engaging the seat with the second annular structure.

24. The fastening mechanism of claim 21, wherein the first connecting component comprises:
a head portion, wherein a first outer dimension of the head portion is bigger than an inner dimension of the first through hole;
a neck portion, connected to the head portion, wherein a second outer dimension of the neck portion is smaller than or equals to the inner dimension of the first through hole; and
a protrusion portion, connected to the neck portion, wherein a third outer dimension of the protrusion portion is bigger than the inner dimension of the first through hole;
wherein the neck portion is disposed in the first through hole, and the head portion and the protrusion portion respectively contact with two opposite sides of the first annular structure for fastening the first connecting component to the first annular structure.

25. The fastening mechanism of claim 21, wherein the first connecting component further has a first fan-shaped portion and a second fan-shaped portion, and the first fan-shaped portion and the second fan-shaped portion are arranged in an annular manner outside the second through hole to receive the seat.

26. The fastening mechanism of claim 25, wherein there exists a clearance between the first fan-shaped portion and the second fan-shaped portion for allowing the first fan-shaped portion to change shape without interference from the second fan-shaped portion.

27. The fastening mechanism of claim 21, wherein the combining hole is an internally threaded hole, the second connecting component is a screw, and the screw fits the internally threaded hole in size and thread, thereby enabling combination between the screw and the internally threaded hole.

28. The fastening mechanism of claim 21, wherein the first connecting component comprises:
a first segment, wherein an inner dimension of the first segment is substantially close to an outer dimension of the second connecting component; and
a second segment, wherein an inner dimension of the second segment is substantially close to an outer dimension of the seat, and the inner dimension of the first segment is smaller than the inner dimension of the second segment;
wherein the first connecting component is disposed in the first through hole, an upper end of the second connecting component is combined with the first segment, and a lower end of the second connecting component passes through the second through hole to be disposed in the combining hole.
